(19) United States
(12) Patent Application Publication
(10) Pub. No.: US 2015/0363157 A1
(43) Pub. Date: Dec. 17, 2015

(54) ELECTRICAL DEVICE AND ASSOCIATED OPERATING METHOD FOR DISPLAYING USER INTERFACE RELATED TO A SOUND TRACK

(71) Applicant: HTC Corporation, Taoyuan County (TW)

(72) Inventors: Yung-Lung CHANG, Taoyuan County (TW); Chen-Yu WANG, Taoyuan County (TW)

(73) Assignee: HTC CORPORATION, Taoyuan County (TW)

(21) Appl. No.: 14/307,324

(22) Filed: Jun. 17, 2014

(51) Int. Cl. G06F 3/16; G11B 27/02; H04N 5/77; G11B 27/34; H04N 9/802; G06F 3/0484; G06F 3/0488

(52) U.S. Cl. CPC G06F 3/165; G06F 3/04847; G11B 27/02; G06F 3/04883; G11B 27/34; H04N 9/802; H04N 5/77

(57) ABSTRACT

An operating method for an electrical device is provided. The electrical device has a display screen. The operating method includes the following steps. First, at least one sound track is provided, wherein the at least one sound track is individually associated with at least one sound source. Then, a user interface (UI) is displayed on the display screen, wherein the UI displays the at least one sound track and at least one indicator corresponding to the at least one sound track, so that the at least one sound track can be edited through the UI. The at least one indicator is configured to indicate the at least one sound source individually.

### BACKGROUND OF THE INVENTION

1. Field of the Invention

The invention relates in general to an electrical device and associated operating method for displaying a user interface (UI), and more particularly to an electrical device and associated operating method for displaying a UI related to a sound track.

2. Description of the Related Art

With the development of technology, now many personal mobile devices have video recording functions. Thus, more and more people use the personal mobile devices to record videos for wonderful things and special events. However, these recorded video usually contain unwanted sounds such as noise. Accordingly, how to remove or turn down the volume of the unwanted sounds in the recorded video becomes an important issue in the field.

### SUMMARY OF THE INVENTION

The invention is directed to an electrical device and associated operating method for presenting a user interface (UI) related to a sound track.

According to an aspect the present invention, an operating method for an electrical device is provided. The electrical device has a display screen. The operating method includes the following steps. First, at least one sound track is provided, wherein the at least one sound track is individually associated with at least one sound source. Then, a user interface (UI) is displayed on the display screen, wherein the UI displays the at least one sound track and at least one indicator corresponding to the at least one sound track, so that the at least one sound track can be edited through the UI. The at least one indicator is configured to indicate the at least one sound source individually.

According to another aspect the present invention, an electrical device is provided. The electrical device includes a processing unit and a display screen. The processing unit is configured to provide at least one sound track, wherein the at least one sound track is individually associated with at least one sound source. The display screen is configured to display a user interface (UI) on the display screen, wherein the UI displays the at least one sound track and at least one indicator corresponding to the at least one sound track, so that the at least one sound track can be edited through the UI, the at least one indicator is configured to indicate the at least one sound source individually.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 illustrates a block diagram of the electrical device according to an embodiment of the invention.

FIG. 2 shows the electrical device which can record video for a number of sound sources.

FIG. 3 illustrates an UI presented by the electrical device under the scenario of FIG. 2.

FIG. 4 illustrates one example of how the user edits the sound tracks through the UI.

FIG. 5 illustrates a flow chart of an example of the method for reducing the environmental noise of the video.

FIG. 6 illustrates the electrical device in which the sound track can be edited while playing the video file according to another embodiment of the invention.

FIG. 7 illustrates the electrical device in which the audio recording directivity can be adjusted while recording video for the sound sources according to another embodiment of the invention.

FIG. 8 illustrates a block diagram of the electrical device according to another embodiment of the invention.

FIG. 9 illustrates the sound sources are located in different sides in relative to the electrical device.

FIG. 10 illustrates an UI presented by the electrical device under the scenario of FIG. 9.

### DETAILED DESCRIPTION OF THE INVENTION

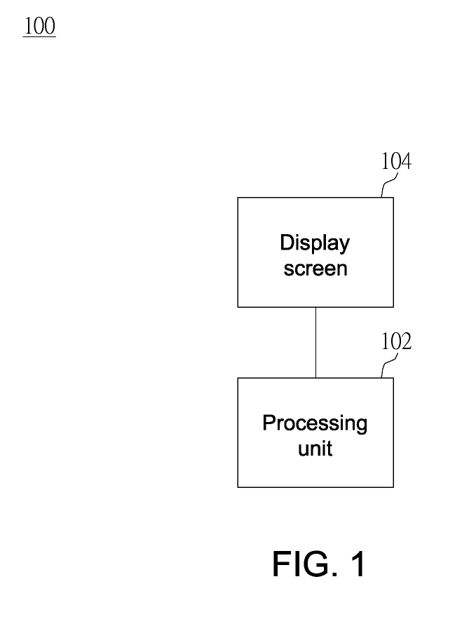

Referring to FIG. 1, a block diagram of the electrical device 100 according to an embodiment of the invention is illustrated. The electrical device 100 includes a processing unit 102 and a display screen 104. The processing unit 102 provides at least one sound track. The at least one sound track is individually associated with at least one sound source. The display screen 104 displays a user interface (UI). The UI displays the at least one sound track and at least one indicator corresponding to the at least one sound track, so that the at least one sound track can be edited through the UI, wherein the at least one indicator is configured to indicate the at least one sound source individually. Through the UI of the electrical device 100, the sounds corresponding to various sound sources in the video can be individually edited in a convenient way, so that the user can have better experience of using the electrical device.

In this embodiment, the electrical device 100 may be, for example, a smart phone or a device capable of recording video. The electrical device 100 is able to record video for the at least sound source to generate a video file, and able to generate the at least one sound track according to the video file. The at least one indicator can be the image of the at least one sound source in a frame of the video file. Or, the electrical device 100 is able to record sound from the at least one sound source to generate an audio file, and able to generate the at least one sound track according to the audio file.

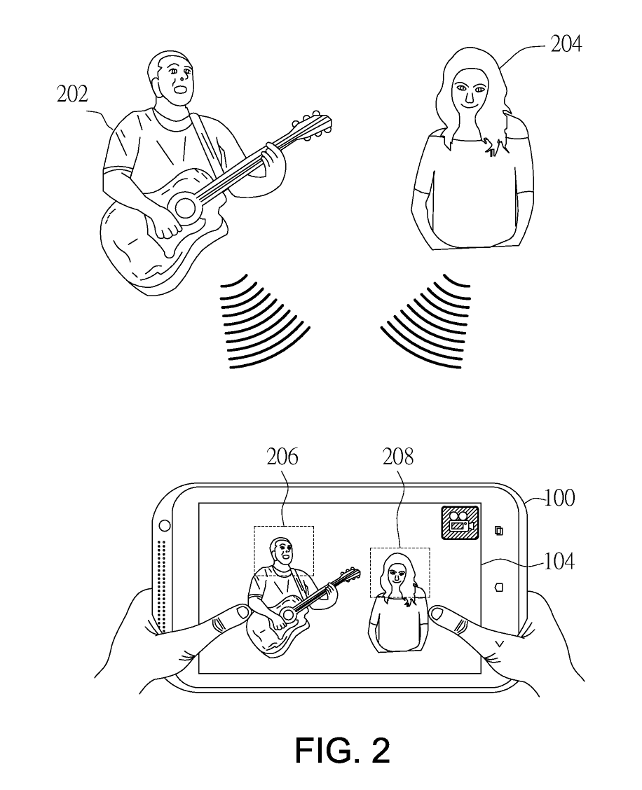

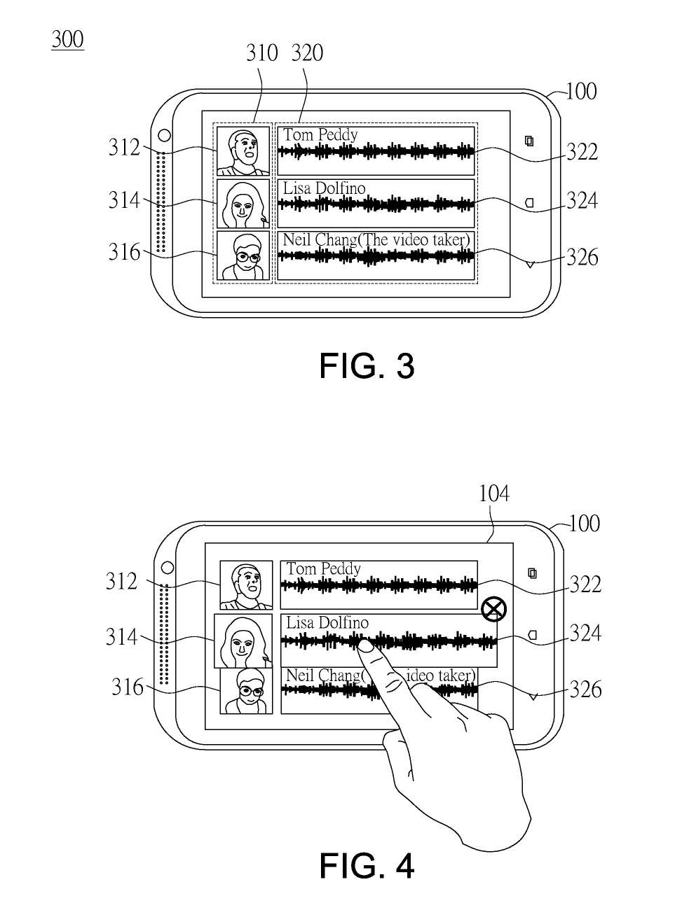

For better illustrations, descriptions are given with reference to FIGS. 2 and 3 below. It can be understood that the present invention is not limited to the examples shown in FIG. 2 and FIG. 3.

FIG. 2 shows the electrical device 100 which can record video for a number of sound sources. As shown in FIG. 2, the electrical device 100 records video for sound sources 202 and 204 to generate a video file. The processing unit 102 generates sound tracks corresponding to the sound sources 202 and 204, respectively, according to the video file, and sets the images of the sound sources 202 and 204 in a frame of the video file as the indicators. For example, the processing unit 102 sets the image in square 206 as the indicator corresponding to the sound source 202, and sets the image in square 208 as the indicator corresponding to the sound source 204.

FIG. 3 illustrates an UI 300 presented by the electrical device 100 under the scenario of FIG. 2. As shown in FIG. 3, the UI 300 includes a first region 310 and a second region 320. The first region 310 is used for displaying the indicator corresponding to the sound sources. In this example, the first region 310 displays the indicators 312 and 314 corresponding to the sound sources 202 and 204, respectively. The second region 320, adjacent to the first region 310, is used for displaying the sound tracks corresponding to the sound sources. In this example, the second region 320 displays the sound tracks 322 and 324 corresponding to the sound sources 202 and 204, respectively. The arrangement order of the indicators 312 and 314 in the first region 310 can be consistent with the sound tracks 322 and 324 in the second region, so that the user may clearly understand that the sound track 322 is corresponding to the sound generated by the sound source 202 corresponding to the indicator 312, and the sound track 324 is corresponding to the sound generated by the sound source 204 corresponding to the indicator 314.

In this embodiment, UI 300 can further display at least one name tag for representing a name corresponding to the at least one sound source, the at least one sound track is corresponding to the at least one name tag. For example, the electrical device 100 can further include a database such as a friend list. The friend list, for example, includes a number of contact items. Each contact item contains the information of the friend, for example, the photo of the friend, the communication information of the contact, and so on. The electrical device 100 identifies the face image of the sound source, and then determines which contact item stored in the database is corresponding to the face image of the sound source by comparing the face image of the sound source and the photo of the friend, for example. If it is determined that there is a contact item corresponding to the face image of the sound source, the electrical device 100 displays the sound track corresponding to the sound source along with a name tag of the corresponding contact item on the display screen 104. Taking FIG. 3 as example, when the electrical device 100 identifies that the face image of the sound source 202 is corresponding to the photo (face image) of contact item named as “Tom Peddy” stored in the friend list, the electrical device 100 may choose the name “Tom Peddy” of this contact item as the name tag of the sound source 202.

In another embodiment, when the electrical device 100 identifies that the face image of the sound source 202 is corresponding to the photo (face image) of contact item named “Tom Peddy” stored in the friend list, the electrical device 100 may choose the photo of contact item named “Tom Peddy” as the indicator of the sound source 202, and displays the photo of contact item named as “Tom Peddy” in the first region 310.

FIG. 4 illustrates one example of how the user edits the sound tracks through the UI 300. The display screen 104 may be, for example, a touch screen. As shown in FIG. 4, when the user wants to edit the sound track 324 corresponding to the sound source 204, the user may directly touch the sound track 324 displayed on the UI 300 to edit the sound track 324. In this embodiment, the at least one sound track can be edited by adding the sound track, deleting the sound track, turning up the volume of the sound track, or turning down the volume of the sound track. The invention is not limited to the above examples. The at least one sound track can be also edited by other operations such as changing the attribute or parameters of the sound track.

In another example, the electrical device 100 can further generate a sound track corresponding to environmental noise, and displays the sound track and the corresponding indicator of the environmental noise on the display screen 104, so that the sound track of the environmental noise can also be edited by a user. For example, the processing unit 102 may generate a sound track, which is not corresponding to any sound source, from the video recoding, and then set this sound track as the environmental noise sound track. In an example, the indicator of the environmental noise sound track may be set by the system or by the user. Generally, the environmental noise sound track is corresponding to the sounds from surroundings when the electrical device 100 records video, such as sound from the objects around the electrical device 100 and not being shown in the video, for example, the sound of the video taker. In this example, the user may reduce or remove the environmental noise in the video by editing the sound track of the environmental noise through the UI, so that the quality of video on the electrical device 100 can be improved.

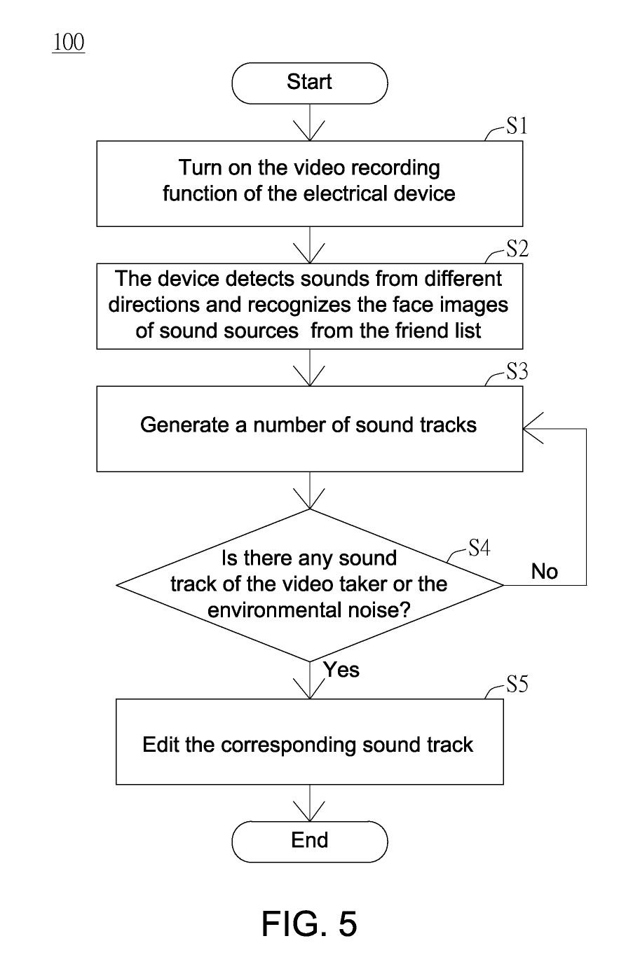

FIG. 5 illustrates a flow chart of an example of the method for reducing the environmental noise of the video. First, at step S1, the video recording function of the electrical device 100 is turned on. Then, at step S2, the electrical device 100 detects sounds from different directions and recognizes the face images of the sound sources from the friend list. Next, at step S3, the electrical device 100 generates a number of sound tracks with name tags. Then, at step S4, the processing unit 102 determines is there any sound track of the user (the video taker) or the environmental noise. If so, the corresponding sound track is edited (deleting or turning down the volume of the sound track) at step S5. If not in step S4, the method goes back to the step S3. Thus, in the situation that video taker talks (or yells) or the environmental noise exists while recording the video, which may interfere the sound from the main subject in the video, the electrical device 100 can separate the unwanted sound (the sound of the video taker or the sound of the environmental noise) and the sound track of the unwanted sound can be edited or deleted to reduce the sound of the video taker or the environmental noise in the video, and therefore the user will have better experience of watching the recorded video.

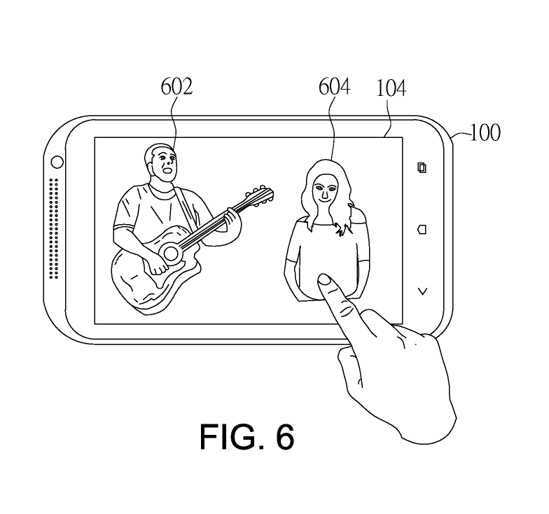

FIG. 6 illustrates the electrical device 100 in which the sound track can be edited while playing the video file according to another embodiment of the invention. In this embodiment, when the electrical device 100 plays the video file which displays the image of the at least one sound source on the display screen 104, the processing unit 102 may turn up or turn down the volume of the sound track corresponding to the at least one sound source in response to a touch operation on the image of the at least sound source. For example, as shown in FIG. 6, the electrical device 100 plays the video file which displays the image 602 of the sound source 202 and the image 604 of the sound source 204 on the display screen 104. At this time, if the user touches one of the sound source images, such as the image 604, the processing unit 102 may turn up or turn down the volume of the sound track 324 corresponding to the sound source 204 in response to the touch operation. In this embodiment, the volume of the sound tracks respectively corresponding to the sound sources in the video file can be adjusted through simple operation.

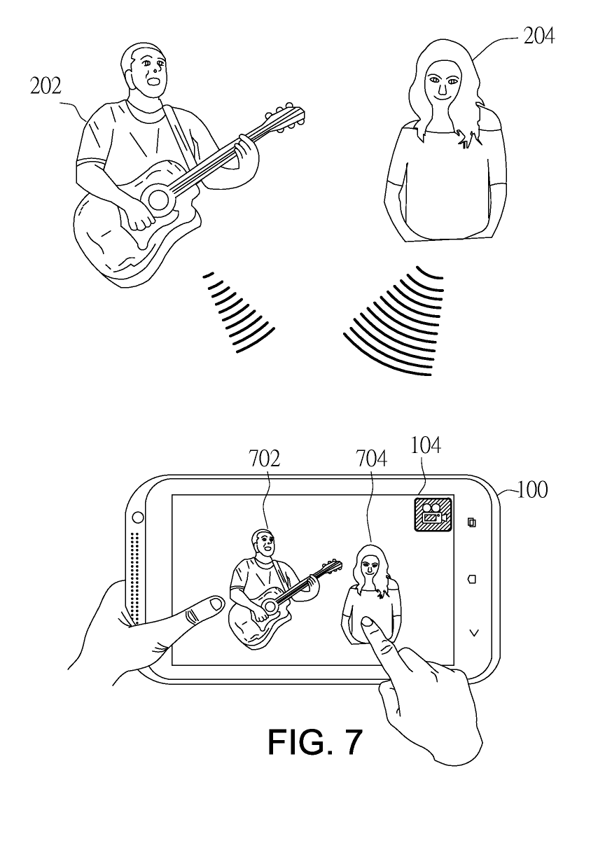

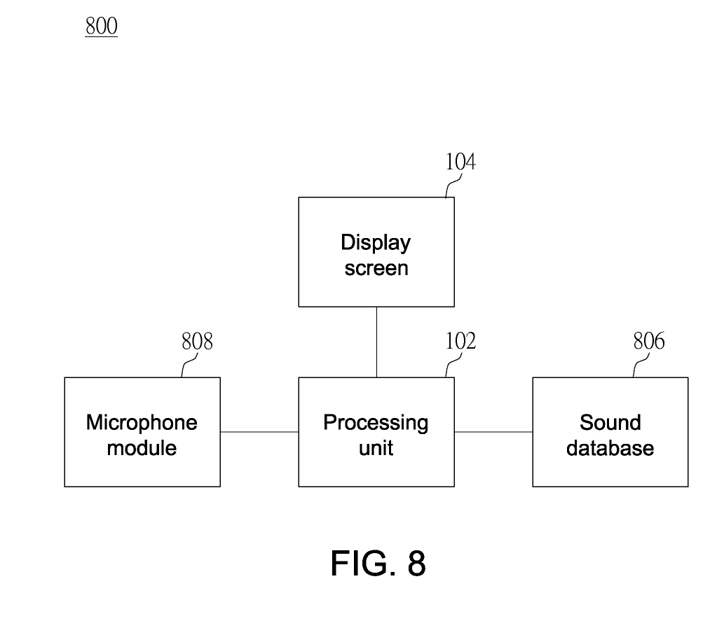

FIG. 7 illustrates the electrical device 100 in which the audio recording directivity can be adjusted while recording video for the sound sources according to another embodiment of the invention. In this embodiment, when the electrical device 100 is recording video for the at least sound source, the processing unit 102 may increase the audio recording directivity to record the sound from a selected sound source in response to a touch operation on the image of the selected sound source. As shown in FIG. 7, the electrical device 100 records video for the sound source 202 and 204, and displays the image 702 of the recorded sound source 202 and the image 704 of the recorded sound source 204 on the display screen 104. At this time, if the user touches the image 704 displayed on the display screen 104, the processing unit 102 may control a microphone module 808 (as shown in FIG. 8) to increase the audio recording directivity to record the sound of the sound source 204 in response to the touch operation. Similarly, if the user touches the image 702 displayed on the display screen 104, the processing unit 102 may control the microphone module 808 to increase the audio recording directivity to record the sound of the sound source 202 in response to the touch operation. In an example, beamforming and digital signal processing (DSP) technology are used to enhance the audio recording directivity of microphone module 808. In this embodiment, the user is able to choose a specific sound source to record its sound in an easy way.

FIG. 8 illustrates a block diagram of the electrical device 800 according to another embodiment of the invention. The main difference from the embodiments shown in FIG. 1 and FIG. 8 relies in that the electrical device 800 further includes a sound database 806 and a microphone module 808.

The sound database 806 is configured to store a number of sound files, each of the sound files is corresponding to a predetermined sound source, and each of the predetermined sound sources is corresponding to a predetermined indicator. The processing unit 102 can compare the at least one sound track with the sound files to determine whether the predetermined sound source corresponding to the at least one sound track exists. When the predetermined sound source corresponding to the at least one sound track exists, the processing unit 102 may set the predetermined indicator corresponding to the predetermined sound source as the at least one indicator.

For example, the sound database 806 may store sound files of the user (or the video taker). When the electrical device 800 identifies that one of the sound tracks is corresponding to the sound files stored in the sound database 806 by voice recognition technology, the processing unit 102 sets the predetermined indicator (the head shot of the user, for example) as the indicator. As shown in FIG. 3, the indicator 316 represents the predetermined indicator of the user (or the video taker), and the sound track 326 represents the sound track of the user. Thus, even if the user (or video taker) is not shown in the video, the electrical device 800 may utilize the voice recognition technology to analysis the recorded voice of the user, and displays the sound track and the indictor which are corresponding the user on the display screen 104, so that the sound track of the user can be edited by the user.

The microphone module 808 has at least two microphones. By using the at least two microphones, the processing unit 102 generates at least one sound incident angle of the at least one sound source relative to the electrical device 100. Besides, the processing unit 102 determines a relative angle between the at least one sound source and the electrical device 800 according to the frame of the video file during recording the video file. The frame of the video file has the image of the at least one sound source. If the at least one sound incident angle is consistent with the relative angle, the processing unit 102 may set the image of the sound source as the at least one indicator corresponding to the at least one sound track.

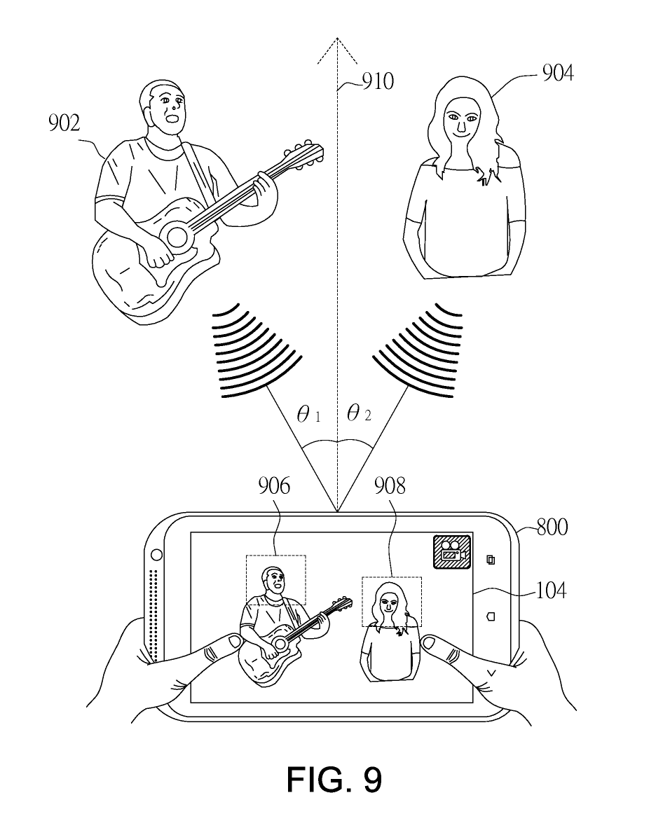

Taking FIG. 9 as example, the sound source 902 is located in the left in relative to the electrical device 800 and the sound source 904 is located in the right in relative to the electrical device 800. The sound incident angle 01 in which the sound from the sound source 902 is received is different from the sound incident angle θ2 in which the sound from the sound source 904 is received. In relative to the normal direction of the plane of the display screen 104 (denoted as the dotted arrow 910 in FIG. 9), the sound incident angle θ1 corresponding to the sound generated from the sound source 902 is −45 degree, and the sound incident angle θ2 corresponding to the sound generated from the sound source 904 is 45 degree, for example. In an example, the electrical device 800 may utilize the phase difference or time difference of the sound wave from the sound source to the microphones module 808 to obtain the sound incident angle.

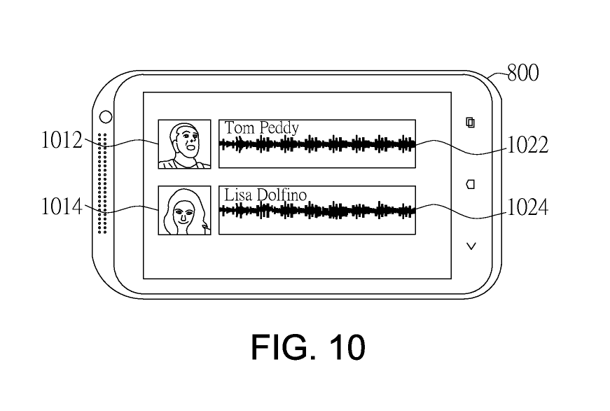

In this embodiment, the processing unit 102 of the electrical device 800 also determines the relative angles between the electrical device 800 and the sound sources 902 and 904 according the captured image during the video recording. For example, when focusing on the sound sources 902 and 904, the focusing system in video recording function is used to obtain the relative angles between the electrical device 800 and the sound sources 902 and 904. Or, the exposure compensation mechanism in video recording function may be used to obtain the relative angles between the electrical device 800 and the sound sources 902 and 904. In FIG. 9, the relative angle between the electrical device 800 and the sound source 902 is −45 degree, and the relative angle between the electrical device 800 and the sound source 904 is 45 degree. Thus, by comparing the abovementioned sound incident angles θ1 and θ2 with the relative angle between the sound sources 904 and the electrical device 800, the processing unit 102 is able to associate the sound tracks of the sound sources with the corresponding indicators (the images of the sound sources, for example). Taking FIG. 10 as example, since the relative angle (−45 degree) between the sound source 902 and the electrical device 800 is consistent with the sound incident angle θ1 (−45 degree), the processing unit 102 associates the sound track 1022 corresponding to the sound source 902 with the corresponding indicator 1012 (the image of the sound source 902 in the square 906) and displays the indicator 1012 and the sound track 1022 in the same row, so the user can clearly understand that the sound track 1022 represents the sound generates by the sound source 902 corresponding to the indicator 1012. Similarly, since the relative angle (45 degree) between the sound source 904 and the electrical device 800 is consistent with the sound incident angle θ2 (45 degree), the processing unit 102 associates the sound track 1024 corresponding to the sound source 904 with the corresponding indicator 1014 (the image of the sound source 904 in the square 908) and displays the indicator 1014 and the sound track 1024 in the same row, so the user can clearly understand that the sound track 1024 represents the sound generates by the sound source 904 corresponding to the indicator 1014.

An operating method for an electrical device having a display screen is further provided according to the embodiments of the present invention. The operating method includes the following steps. First, at least one sound track is provided, wherein the at least one sound track is individually associated with at least one sound source. Then, a user interface (UI) is displayed on the display screen, wherein the UI displays the at least one sound track and at least one indicator corresponding to the at least one sound track, so that the at least one sound track can be edited through the UI. In the embodiment, the at least one indicator is configured to indicate the at least one sound source individually.

Based on the above, the electrical device according to the embodiments of the invention enables sounds in video separate and editable. Through the UI of the electrical device, the sounds corresponding to various sound sources in videos can be edited in an easy and convenient way, so that the user can have better experience of using the electrical device. Moreover, in some embodiment, the user can simply turn up or turn down the volume of the sound track by touching the image of the sound source displayed on the display screen.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An operating method for an electrical device having a display screen, comprising:
providing at least one sound track, wherein the at least one sound track is individually associated with at least one sound source; and
displaying a user interface (UI) on the display screen, wherein the UI displays the at least one sound track and at least one indicator corresponding to the at least one sound track, so that the at least one sound track can be edited through the UI, the at least one indicator is configured to indicate the at least one sound source individually.

2. The operating method according to claim 1, wherein the at least one sound track can be edited by adding the sound track, deleting the sound track, turning up the volume of the sound track, or turning down the volume of the sound track.

3. The operating method according to claim 1, further comprising:
recording sound from the at least one sound source to generate an audio file; and
generating the at least one sound track according to the audio file.

4. The operating method according to claim 1, wherein the electrical device comprises a sound database for storing a plurality of sound files, each of the sound files is corresponding to a predetermined sound source, each of the predetermined sound sources is corresponding to a predetermined indicator, the operating method further comprises:
comparing the at least one sound track with the sound files to determine whether the predetermined sound source corresponding to the at least one sound track exists; and
when the predetermined sound source corresponding to the at least one sound track exists, setting the at least one indicator as the predetermined indicator corresponding to the predetermined sound source.

5. The operating method according to claim 1, further comprising:
recording sound from the at least sound source to generate a video file; and
generating the at least one sound track according to the video file;
wherein the at least one indicator is an image of the at least one sound source in a frame of the video file.

6. The operating method according to claim 5, further comprising:
playing the video file which displays the image of the at least one sound source on the display screen; and
in response to a touch operation on the image of the at least sound source, turning up or turning down the volume of the sound track corresponding to the at least one sound source.

7. The operating method according to claim 1, wherein the electrical device comprises at least two microphones, the operating method further comprises:
generating at least one sound incident angle of the at least one sound source relative to the electrical device by using the at least two microphones;
determining a relative angle between the at least one sound source and the electrical device according to a frame of the video file during recording the video file, the frame of the video file having an image of the at least one sound source; and
setting the image of the sound source as the at least one indicator corresponding to the at least one sound track if the at least one sound incident angle is consistent with the relative angle.

8. The operating method according to claim 1, wherein the UI further displays at least one name tag for representing a name corresponding to the at least one sound source, the at least one sound track is corresponding to the at least one name tag.

9. An electrical device, comprising:
a processing unit for providing at least one sound track, wherein the at least one sound track is individually associated with at least one sound source; and
a display screen for displaying a user interface (UI) on the display screen, wherein the UI displays the at least one sound track and at least one indicator corresponding to the at least one sound track, so that the at least one sound track can be edited through the UI, the at least one indicator is configured to indicate the at least one sound source individually.

10. The electrical device according to claim 9, wherein the at least one sound track can be edited by adding the sound track, deleting the sound track, turning up the volume of the sound track, or turning down the volume of the sound track.

11. The electrical device according to claim 9, wherein the processing unit records sound from the at least one sound source to generate an audio file, and generates the at least one sound track according to the audio file.

12. The electrical device according to claim 9, wherein the electrical device further comprises a sound database for storing a plurality of sound files, each of the sound files is corresponding to a predetermined sound source, each of the predetermined sound sources is corresponding to a predetermined indicator;
wherein the processing unit compares the at least one sound track with the sound files to determine whether the predetermined sound source corresponding to the at least one sound track exists, when the predetermined sound source corresponding to the at least one sound track exists, the processing unit sets the at least one indicator as the predetermined indicator corresponding to the predetermined sound source.

13. The electrical device according to claim 9, wherein the electrical device records sound from the at least sound source to generate a video file, and generates the at least one sound track according to the video file;
wherein the at least one indicator is an image of the at least one sound source in a frame of the video file.

14. The electrical device according to claim 13, wherein when the electrical device plays the video file which displays the image of the at least one sound source on the display screen, the processing unit turns up or turns down the volume of the sound track corresponding to the at least one sound source in response to a touch operation on the image of the at least sound source.

15. The electrical device according to claim 9, wherein the electrical device further comprises at least two microphones;
wherein the processing unit generates at least one sound incident angle of the at least one sound source relative to the electrical device by using the at least two microphones;
wherein the processing unit determines a relative angle between the at least one sound source and the electrical device according to a frame of the video file during recording the video file, the frame of the video file having an image of the at least one sound source;
wherein the processing unit sets the image of the sound source as the at least one indicator corresponding to the at least one sound track if the at least one sound incident angle is consistent with the relative angle.

16. The electrical device according to claim 9, wherein the UI further displays at least one name tag for representing a name corresponding to the at least one sound source, the at least one sound track is corresponding to the at least one name tag.
